(19) United States
(12) Patent Application Publication
(10) Pub. No.: US 2026/0119560 A1
(43) Pub. Date: Apr. 30, 2026

(54) SYSTEM AND METHOD FOR PROVIDING INTENT ACTION FEEDBACK SUMMARIES TO A USER USING AN ARTIFICIAL INTELLIGENCE PRODUCTIVITY TOOL

(71) Applicant: Dell Products LP, Round Rock, TX (US)

(72) Inventors: Srikanth Kondapi, Austin, TX (US); Daniel L. Hamlin, Round Rock, TX (US); Balasingh Ponraj Samuel, Round Rock, TX (US)

(73) Assignee: Dell Products LP, Round Rock, TX (US)

(21) Appl. No.: 18/929,500

(22) Filed: Oct. 28, 2024

(51) Int. Cl. G06F 16/34; G06F 40/35

(52) U.S. Cl. CPC G06F 16/345; G06F 40/35

(57) ABSTRACT

A system and method of providing an intent action feedback summary at an information handling system comprising a hardware processor executing computer-readable program code instructions of an artificial intelligence (AI) productivity tool software module to receive a user query input and identify a plurality of responsive capabilities associated with AI productivity tool-enablable software applications and execute a transaction software module to determine that a capability intent action responsive to one of the identified plurality of responsive capabilities requires user approval or additional user chat input. The hardware processor executing computer readable code instructions of a retrieval augmented generation large language model algorithm to receive, as input, document knowledgebase text data and generate a summary of the identified plurality of responsive capabilities in human-readable output for display to conduct the additional user chat input for user approval or customization data for the execution of the identified plurality of responsive capabilities.

### FIELD OF THE DISCLOSURE

The present disclosure generally relates to execution of computer-readable program code instructions for one or more artificial intelligence (AI) productivity tools. The present disclosure more specifically relates systems and methods of providing a generated capability intent action feedback summary to a user using the AI productivity tool at the information handling system after capability intent actions have been identified in response to user query input.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workspace productivity applications such as for teleconferencing, word processing, sales systems, business software, gaming applications, or the like.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system executing computer readable code instructions of an AI productivity tool software module to select among a plurality responsive capabilities of AI productivity tool-enablable software applications to a user query input and provide a generated capability intent action feedback summary to a user for additional user chat inputs at an information handling system according to an embodiment of the present disclosure;

FIG. 2 is a graphic and block diagram illustrating an information handling system executing computer readable code instructions of an AI productivity tool software module to select among a plurality responsive capabilities of AI productivity tool-enablable software applications to a user query input and provide a generated capability intent action feedback summary and an executed capabilities log according to an embodiment of the present disclosure; and

FIG. 3 is a flow diagram showing a method of executing computer readable code instructions of an AI productivity tool software module providing a generated capability intent action feedback summary to a user for additional user chat inputs at an information handling system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Artificial intelligence (AI) is a developing technology that is used to increase the efficiency of computing systems and humans alike. The information handling system of embodiments of the present disclosure may include AI productivity tools that interface with various AI productivity tool-enablable software applications that increase the efficiency of the operation of the information handling system. An example of AI technologies includes, but is not limited to, computer-readable program code instructions of an AI productivity tool such as for chat-enabled environments (voice, text, etc.). Often, these chat-enabled environments are described as AI productivity tool software modules that receive this voice or text input from a user and implement a number of actions or responses based on the natural language of the input. In some information handling systems, plural AI productivity tool software modules, as provided by one or more independent software vendors (ISVs) or provided by an original equipment manufacturer (OEM) of the information handling system, may interface with computer-readable program code instructions of various AI productivity tool-enablable software applications being executed or executable on the information handling system in embodiments herein. In an embodiment, each of the plural AI productivity tool modules, from the one or more ISVs such as an operating system (OS) provider or the information handling system manufacturer (e.g., the OEM), may have published or designated capabilities which may respond to a user query input.

These AI productivity tool-enablable software applications may integrate with the plural AI productivity tool software modules to allow user queries to trigger certain capability intent actions declared, supported, and managed or conducted by these AI productivity tool-enablable software applications to provide responsive hardware or software operations in services, or a generate responses to the user input query. To support this process, however, the user may be required to provide additional user inputs for the execution of the AI productivity tools at the information handling system resulting in identified responsive capabilities and those AI productivity tool-enablable software applications used to execute those capabilities and associated capability intent actions. The user may not be provided with visibility into the execution of the responsive capability intent actions provided or to be provided via these AI productivity tools to provide informed additional user chat inputs in an multi-turn user chat exchange. Still further, an internet technology decision maker (ITDM) may also want to know which, if any, capability intent actions were accepted by the user and be benefits of the execution of those capability intent actions.

The present specification, therefore, describes a system and method to provide a generated capability intent action feedback summary to a user at the information handling system. The system and method may include a hardware processor, a data storage device, and a power management unit (PMU) to provide power to the hardware processor and data storage device. In an embodiment, the hardware processor may execute computer-readable program code instructions of an artificial intelligence (AI) productivity tool software module to receive a user query input and direct an AI productivity tool plugin to invoke a plurality of machine learning (ML) model algorithms to identify a plurality of responsive capabilities associated with the AI productivity tool-enablable software applications and the plug-in AI productivity tool-enablable software applications that semantically or lexically match as responsive to the user query input. This identifies one or more responsive capabilities that can be executed by one or more AI productivity tool-enablable software applications in response to the user query input from the user.

In an embodiment, the hardware processor may also execute computer-readable program code instructions of a transaction software module to determine that a capability intent action responsive to one of the identified plurality of responsive capabilities requires user approval or additional customizing input. Further, the transaction software module may determine that a user is or will be providing additional user chat inputs in an ongoing multi-turn additional user chat exchange with the AI productivity tool software module in some embodiments. The hardware processor to execute computer-readable program code instructions of the transaction software module to invoke a retrieval augmented generation (RAG) LLM algorithm to receive, as input, document knowledgebase text data via access to one or more document knowledgebase databases and generate a summary of the identified plurality of responsive capabilities in human-readable output. This allows the hardware processor to execute the computer-readable program code instructions of the transaction software module to display the generated capability intent feedback summary of the identified plurality of responsive capabilities in human-readable output on a video/graphics display device of the information handling system.

The generated capability intent feedback summary of the identified plurality of responsive capabilities in human-readable output on the video/graphics display device may be used with the multi-turn additional user chat exchange for the user to approve the execution of the identified plurality of responsive capabilities, provide customizing inputs such as a desired level, or other additional user chat inputs. A user may be provided with this user interface or graphical user interface (GUI) of the generated capability intent feedback summary that describes in human-readable output text all identified capabilities that can be carried out on the information handling system with the user given the ability to select which, if any, of these identified capabilities should be carried out while providing additional user chat inputs. When selected, the selection may be recorded and one or more of these responsive capabilities may be carried out by the AI productivity tools to improve user functionality at the information handling system. Thus, human-readable output as understandable text is provided to the user based on the document knowledgebase text data accessible to the user which is used along with application programming interface (API) data for execution of the identified responsive capabilities to inform the selection of the human-readable output text description of those responsive capabilities in an embodiment. This human-readable output text description of those responsive capabilities may provide the user with specific details related to each of the identified capabilities providing information to the user that would otherwise not be available and assist in understanding of the capability intent action proposed.

In an embodiment, the hardware processor may execute computer-readable program code instructions of the transaction software module to generate an executed capabilities log describing user-approved capabilities executed at the information handling system. The AI productivity tool software module may then transmit that executed capabilities log to a remote management server accessible to an intent technology decision maker (ITDM). Additionally, the AI productivity tool software module may transmit the generated capability intent feedback summary of the identified plurality of responsive capabilities in human-readable output, the user query input, or additional chat inputs of the additional user chat exchange to the remote management server in various embodiments. This further allows an ITDM to discern effectiveness of the AI productivity tool software module, which capabilities were accepted by the user and how those capabilities were described to the user via execution of the transaction software module and the RAG LLM algorithm, and make modification or improvements.

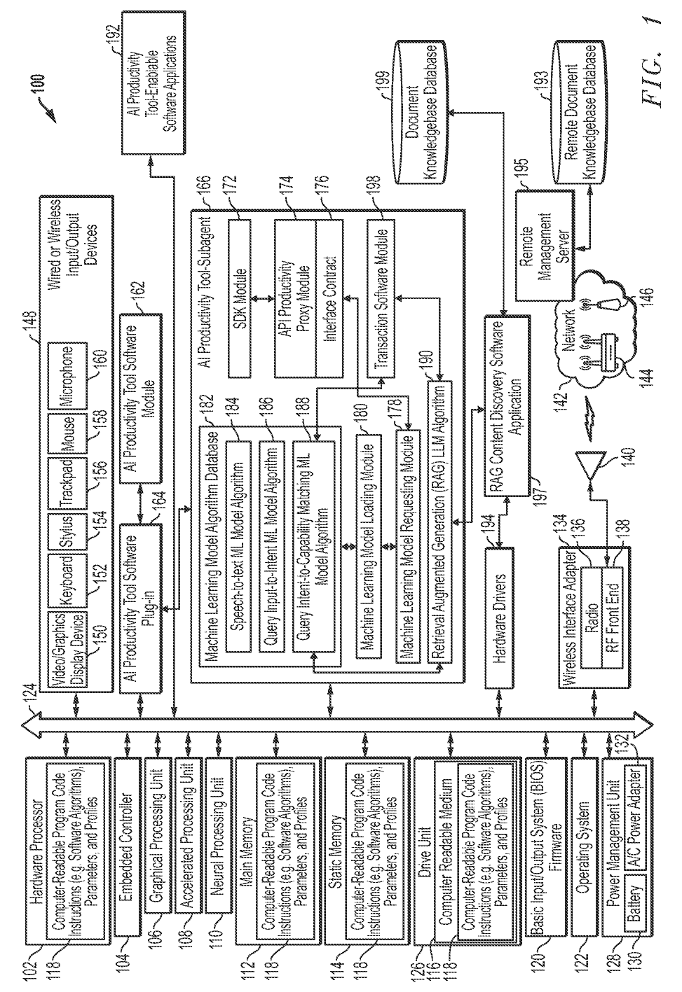

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a video/graphics display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resources (e.g., 104, 106, 108, 110). Any of the hardware processing resources may operate to execute computer readable code instructions that are either firmware or software code, such as those software systems and modules described herein in execution of orchestrating a plurality of capabilities from plural AI productivity tool software module 162. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, video/graphics display device 150, stylus 154, trackpad 156, microphone 160, among other peripheral devices.

As described herein, the information handling system 100 further includes a video/graphics display device 150. The video/graphics display device 150 in an embodiment may function as a liquid crystal display (LCD), an organic light emitting diode (OLED), a flat panel display, or a solid-state display. It is appreciated that the video/graphics display device 150 may be wired or wireless and may be an external video/graphics display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the video/graphics display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 144 or base station 146 used to operatively couple the information handling system 100 to a network 142 via a wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, a video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 to provide this power. The PMU 128 may be coupled to the bus 124 to provide or receive data or machine-readable code instructions. The PMU 128 may regulate power from a power source such as the battery 130 or AC power adapter 132. In an embodiment, the battery 130 may be charged via the AC power adapter 132 and provide power to the components of the information handling system 100, via wired connections as applicable, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool software module 162 and an AI productivity tool software plug-in 166 to receive user query input and provide that user query input to the AI productivity tool subagent 166. The AI productivity tool software module 162 may include an original equipment manufacturer (OEM) AI productivity tool with a set of capabilities that are executable on the information handling system 100 in embodiments of the present disclosure. Other AI productivity tool software modules may also operate at the information handling system 100 and work in tandem with AI productivity tool software module 162 in some embodiments, such as for operating system 122 or various software systems added to the information handling system. In the embodiments herein, the user query input may include audio input received from, for example, the microphone 160. In another embodiment, the user query input may include text input by the user by the keyboard 152. In an embodiment, the execution of the computer-readable program code instructions 118 of the AI productivity tool subagent 166 by the hardware processor 102 or any other hardware processing device selects among a plurality of available ML module algorithms 184, 186, 188 maintained within a ML model algorithm database 182 for use with execution of the AI productivity tool software module 162 or other AI productivity tool software modules that may be present.

The AI productivity tool software module 162 may invoke one or more sets of capabilities of AI productivity tool-enablable software applications 192 executable on the information handling system 100 according to embodiments of the present disclosure. As described herein, the computer-readable program code instructions 118 of the AI productivity tool software module 162 with an AI productivity tool subagent 166 as well as available ML module algorithms 184, 186, 188 may be executed by a hardware processor 102 or hardware processing resource on the information handling system 100. The execution of code instructions of the AI productivity tool subagent 166 as well as available ML module algorithms 184, 186, 188 thereby allow the processes of the AI productivity tool software module 162 to identify one or more responsive capabilities from among their various sets of available capabilities and respond to received user query inputs according to methods described herein. The execution of the AI productivity tool subagent or subagent 166 as well as available ML module algorithms 184, 186, 188 for the AI productivity tool software module 162 may be carried out on-the-box such that a wired or wireless network connection to a network is not necessary for operation of the method. In another embodiment, some modules, databases, and/or processing resources such as ML module algorithms 184, 186, 188 may be maintained on a remote server (e.g., remote management server 195) such that a wired or wireless network connection can be made with these remote servers and the method may be implemented as described herein.

The AI productivity software tool module 162 may include any artificial intelligence-based productivity tool to assist in interfacing with and execution of the AI productivity tool-enablable software applications 192 and receive user query inputs from a user and generate responses as responsive capability intent actions at an information handling system 100. The AI productivity tool software module 162 may be loaded on-the-box by an OEM manufacturer or other AI productivity tool software modules 162 may be uploaded via uploads in software from one or more independent software vendor (ISVs), such as an operating system ISV. The AI productivity software tool module 162 may include chatbot features, virtual assistant features, and other artificial intelligence features that allow a user to provide input to the information handling system 100 and, with generative artificial intelligence processing of the user query input, execute one or more responsive capabilities from various sets of capabilities that include hardware operations, functions, software services such as by using one or more AI productivity tool-enablable software applications 192. Examples of some types of AI productivity software tool modules 162 may include Cortana ® by Microsoft ®, Copilot ® by Microsoft ®, Siri ® by Apple ® Inc., Gemini ® by Google AI®, ChatGPT ® by OpenAI ®, and Amazon Alexa ® by Amazon ®, among others. It is appreciated that the information handling system 100 may include any proprietary AI productivity tool software module 162 that is an OEM AI productivity tool installed by an information handling system 100 manufacturer and used to interface with the information handling system 100 and the operations thereon. In various embodiments, the hardware processor 102 or other alternative hardware processing resources of the information handling system 100 may execute computer-readable program code instructions of the AI productivity software tool module 162 and the AI productivity tool plug-in 164 to monitor for user input for a user query at a microphone 160, keyboard 152, or other input device for the AI productivity tool subagent 166 to engage in determining capability intent actions responsive to the user query input.

The AI productivity software tool module 162, executing on the hardware processor 102, such as a CPU, or other hardware processing resource (e.g., EC 104, GPU 106, APU 108, or NPU 110), may interface with other hardware components and with the AI productivity tool-enablable software application 192 as well as the one or more ML module algorithms 184, 186, 188 via an AI productivity tool plug-in 166. The AI productivity tool plug-in 166 may be any software or firmware that allows the AI productivity tool subagent 166 to perform processes of the AI productivity software tool module 162 to determine capability intent actions responsive to a user query input at the information handling system 100 based on specific types of user query input (e.g., typed, spoken words, images, etc.) provided from the user, and in embodiments of the present disclosure. The AI productivity tool plug-in 164 may be used by the AI productivity software tool module 162 and AI productivity tool subagent 166 to interface with any number of AI productivity tool-enablable software applications 192 executing or executable on the information handling system 100 according to embodiments herein.

Again, the information handling system 100 also includes the AI productivity tool subagent 166 associated with the AI productivity software tool module 162. The AI productivity tool subagent 166 may be any software and/or firmware executable by the hardware processor 102 or other hardware processing resources 102, 104, 106, 108, 110 of the information handling system 100 to interface with one or more of the plurality of the AI productivity tool-enablable software applications 192 to provide AI enabled capabilities within those AI productivity tool-enablable software applications 192 for responsive hardware, firmware, or software operations, functions, software services, or responses to user input queries. The AI productivity tool subagent 166 executes to access application program interfaces (APIs) for capabilities for those AI productivity tool-enablable software applications 192 published and stored in a natural language capabilities database. The capability APIs for the AI productivity tool-enablable software applications 192 may be used to invoke the AI productivity tool-enablable software applications 192 to execute responsive capability intent actions associated with identified responsive capabilities to a user query input. Such APIs for the AI productivity tool-enablable software applications 192 may be invoked by the API productivity proxy module 174 of the AI productivity tool subagent 166 when a responsive capability is identified. In an embodiment, the computer-readable program code instructions of the AI productivity tool-enablable software applications 192 may operate wholly “on-box” within the information handling system 100 or be sub-agents on-box for interfacing with remote software systems executing at remote server locations.

In an embodiment, the AI productivity tool subagent 166 may be used to direct the execution of various modules in support of one or more identified productivity tool operations by the AI productivity tool-enablable software application 192 and AI productivity software tool module 162 in responding to user query inputs described herein. Additionally, the AI productivity tool subagent 166 may be provided with access to the BIOS 120 and OS 122 of the information handling system 100. Examples of identified productivity tool operations include execution of code instructions of the AI productivity software tool module 162 to determine user-query intent values, match these with generated capability intents, and to execute code instructions of the AI productivity tool-enablable software applications 192 to conduct commensurate capability intent actions pursuant to the user’s query input.

In an embodiment, during operation, the hardware processor 102 or other hardware processing resource (e.g., EC 104, GPU 106, CPU, APU 108, or NPU 110) executes computer-readable program code instructions of the AI productivity tool subagent 166. The AI productivity tool subagent or subagents 166 may engage with a machine learning model requesting module 178 to have one or more ML module algorithms 184, 186, 188 loaded and executed on the hardware processor in order to, initially, determine the query intent value of a user query input and to correlate it with a capability intent action to be conducted responsive to the received user query inputs.

In an embodiment, the execution of the computer-readable program code instructions of the AI productivity tool subagent 166 may call a software development kit (SDK) module 172. The SDK module 172 may include any computer-readable program code instructions that is executed by the hardware processor 102 or other hardware processing resource to request that a ML module algorithms 184, 186, 188 that may be invoked to support the identification of, in an embodiment, one or more capability intent action based on received user query inputs from a user at the AI productivity software tool module 162.

In example embodiments herein, the ML module algorithms 184, 186, 188 may include a query input-to-intent ML model algorithm 186 that receives the user query input, and with an embedding algorithm generates a vectorized query intent value for the user query input for later correlation with a capability intent value. In embodiments where the user query input is in audio form, the AI productivity tool subagent 166, via the SDK module 172, may invoke the execution of a speech-to-text ML model algorithm 184 to initially convert this audio into text for use with the query input-to-intent ML model algorithm 186 to generate the vectorized query intent value for the user query input for later correlation with a capability intent value as described herein. In an example embodiment, the ML module algorithms 184, 186, 188 may also include a query intent-to-capability matching ML model algorithm 188. The query intent-to-capability matching ML model algorithm 188 receives the vectorized query intent value from the execution of the query input-to-intent ML model algorithm 186 as input and then matches the vectorized query intent value to a vectorized capability intent value associated with the AI productivity tool-enablable software application 192 via a similarity correlation algorithm for lexical or semantic matching to identify a responsive capability that can serve as the capability intent action responsive to a user query input.

In embodiments of the present disclosure, the capabilities may include capabilities associated with the AI productivity tool-enablable software application 192 as accessible through the AI productivity software tool module 162. Example AI productivity tool-enablable software applications 192 may include Dell ® Optimizer®, Dell® SupportAssist®, as well as any other AI productivity tool-enablable software applications 192 described herein that can change features, settings, or other actions on the information handling system associated with, for example, information handling system 100 adjustments or adjustments to built-in peripheral devices. It is appreciated that capabilities associated with these AI productivity tool-enablable software applications 192 may include adjustments to a brightness of the video/graphics display device 150, power adjustments at the PMU 128, adjustment to thermal tables (fan/acoustic/hardware processor throttling), system firmware indicator of attacks (IoAs), firmware vulnerability exposure and recommended migrations via Dell® Trusted Device®, among other changes to features, settings, or other characteristics on the information handling system 100.

It is appreciated that the selected ML module algorithms 184, 186, 188 for a similar or common identified AI productivity-tool operation type may satisfy an interface contract 176 requested by the AI productivity tool subagent 166 such that the query intent value from the user query inputs may be interpreted and an available capability associated with one of the plurality of AI productivity tool-enablable software applications 192 as the capability intent action can be matched to the user’s query input. The interface contract 176 described herein defines the requirements that selected ML module algorithms 184, 186, 188 are to have in order to be able receive a specific type of input from the AI productivity tool software module 162, the AI productivity tool subagent 166, or any AI productivity tool-enablable software application 192 and to provide a specific type of output to the AI productivity tool subagent 166, the AI productivity tool software module 162, and/or AI productivity tool-enablable software applications 192. In an embodiment, the interface contract 176 is generated by an AI productivity proxy API 174 invoked by the SDK module 172 in order to identify the similar or common productivity-tool operation type ML module algorithms 184, 186, 188 that provides the appropriate output to the AI productivity tool subagent 166.

As described herein, the plurality of identified capabilities associated with any of the AI productivity tool-enablable software applications 192 as responsive to a user query input may be received by a transaction software module 198. In an embodiment, the receipt of these identified capabilities by the transaction software module 198 occurs prior to the capability intent actions associated with each of the identified capabilities being carried out by their respective AI productivity tool-enablable software applications 192. Execution of the computer-readable program code instructions, parameters, and profiles 118 of the transaction software module 198 causes a determination to be made as to whether additional user chat inputs will occur in an embodiment. For example, the transaction software module 198 may determine that the user needs to consent to the execution of those identified capabilities or that additional customizing input may be required for a responsive capability, such as an indication of a level in various embodiments (e.g., a volume level, brightness level, or others for a capability intent action to adjust volume or brightness). In some example embodiments, some of the capabilities may not need authorization from the user in order to be executed when, for example, the capability is associated with an AI productivity tool-enablable software applications 192 that periodically executes their capabilities such as an antivirus or antimalware AI productivity tool-enablable software application 192. However, the AI productivity tool software module 162 may execute a user conversational interface that indicates that a multi-turn additional chat exchange is occurring with the user indicating to the transaction software module 198 that additional user chat inputs are or will be received which may modify responsive capability selection or responses to the user in other embodiments.

In some example embodiments, the execution of the computer-readable program code instructions, parameters, and profiles 118 of the transaction software module 198 may determine that some or all identified capabilities need approval from the user prior to execution of the capabilities by one or more of the AI productivity tool-enablable software applications 192. In other embodiments, the transaction software module 198 may determine that some or all identified capabilities need additional user chat inputs for customizing levels or details. In yet other embodiments, the transaction software module 198 may determine from the AI productivity tool software module 162 that additional user chat inputs are occurring which may modify some or all identified capabilities. In order to solicit this additional user chat input, such as approval to execute the identified capabilities or customizing input, the transaction software module 198 may invoke a retrieval augment generation (RAG) LLM algorithm 190. The RAG LLM algorithm 190 may include any computer-readable program code instructions that receives input from one or more sources and provides as output human-readable text that is then presented to a user to read and act on accepting or not accepting the implementation of the identified capabilities in embodiments herein.

In an embodiment, a number of sources that contain document knowledgebase text data forming one or more document knowledgebase databases 199 or 193. This document knowledgebase text data may be drawn from user guides (associated with the information handling system or AI productivity tools), integration guides, frequently asked questions (FAQs) sources, hardware specifications, and the like. The document knowledgebase text data can be used as input at the RAG LLM algorithm 190 along with identified responsive capability to determine context embeddings and capability labels in text format that can be used to generate human-readable output describing the identified responsive capabilities and presented to a user. In an embodiment, execution of computer-readable program code instructions, parameters, and profiles 118 of a RAG content discovery software application 197 may be initiated by the transaction software module 198 to discover any pertinent information to the responsive capabilities from the document knowledgebase text data in a document knowledgebase database 199, 193 such as user guides associated with the information handling system or AI productivity tools, integration guides, frequently asked questions (FAQs) sources, hardware specifications, and the like.

In an example embodiment, the information handling system 100 may include a document knowledgebase database 199 that stores, for example, any user guides (associated with the information handling system or AI productivity tools), integration guides, FAQs sources, and hardware specifications associated with the hardware and software (e.g., AI productivity tool-enablable software applications 192) that have document knowledgebase text data that may be associated with any of the identified capabilities. The document knowledgebase database 199 may be propagated with this information by the OEM or ISV during manufacture of the information handling system 100 and/or uploading of the software from the ISV. Additionally, the information handling system 100 may gain access to a remote document knowledgebase database 193 on a remote management server 195 that may include the same or additional user guides (associated with the information handling system or AI productivity tools), integration guides, FAQs sources, and hardware specifications. This remote management server 195 and remote document knowledgebase database 193 may be accessed through the use of the wireless interface adapter 134 accessing a network 142 where the remote management server 195 is located as described in embodiments herein.

In an embodiment, any number of hardware drivers 194 may be accessed to also gain additional specifications related to each hardware device within the information handling system 100. In an embodiment, these additional document knowledgebase text data for details regarding the make and model of the hardware devices, associated processing or storage resources, current driver details, and the like may also be used as input to the RAG LLM algorithm 190.

As described herein, as this input is provided to the RAG LLM algorithm 190 by the RAG content discovery software application 197, output may be received at the transaction software module 198 describing, in human-readable form, as a generated capability intent feedback summary description of those identified responsive capabilities and the hardware, firmware, and/or software that will be affected by the execution of these responsive capabilities. In an embodiment, the human-readable output may also include a generated capability intent feedback summary description of which AI productivity tool-enablable software application 192 will execute their respective capability in order to invoke changes to features, settings, or other actions on the information handling system as described herein. In an embodiment, this human-readable generated capability intent feedback summary output may be presented to the user as a transaction graphical user interface (GUI) presented on, for example, the video/graphics display device 150. Additionally, the user query input, additional user chat inputs, and AI productivity tool software module 162 responses may be presented. In an embodiment, the user may read the presented information on the transaction GUI related to each discovered capability and their respective AI productivity tool-enablable software application 192 and confirm, via actuation of any button presented on the GUI for example, or input customizing data for that capability such that the capability intent action may be executed by the identified AI productivity tool-enablable software applications 192. In other embodiments, the user may provide approval, customizing data, or modifications via additional user chat inputs via a multi-turn chat exchange with the AI productivity tool software module 162.

The systems and methods described herein, therefore, allow for a user to be notified of change to features, settings, or other actions on the information handling system through execution of the computer-readable program code instructions, parameters, and profiles 118 of the transaction software module 198 during a multi-turn user chat exchange described herein. In an embodiment, the user is made aware of detected capabilities responsive to the user’s user query input via human-readable text presented on a transaction GUI prior to the execution of those capabilities. This allows the user to know exactly which capabilities are being executed, how they will affect the operation of the information handling system 100, and which AI productivity tool-enablable software application 192 will be executing those responsive capabilities for responding with additional user chat inputs in a multi-turn user chat exchange with the AI productivity tool software module 162. This provides the user with an opportunity for additional customization by additional user chat inputs when providing user query input to the AI productivity tool software module 162 to trigger one or more responsive capability intent actions.

In an embodiment, the transaction software module 198 may further generate a generate a capability execution log describing responsive capabilities executed, including user-approved capabilities, at the information handling system 100 and transmit that capability execution log to the remote management server 195 accessible to an intent technology decision maker (ITDM) for analysis by the ITDM. Additionally, the human-readable generated capability intent feedback summary output of the identified responsive capabilities as well as the user query input, additional user chat inputs, and AI productivity tool software module 162 responses may be sent to the remote management server 195. This data may provide the ITDM with additional information related to how the user customizes the execution of various capabilities identified after the user has provided user query input to the AI productivity tool software module 162. The ITDM may use this information to, for example, propagate similar customizations to other information handling systems within an enterprise thereby leveraging this customization for other users of other information handling systems in some embodiments. In other embodiments, the ITDM may use this information to make modifications or improvements to the AI productivity tool software modules 162 deployed or to available capabilities provided.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

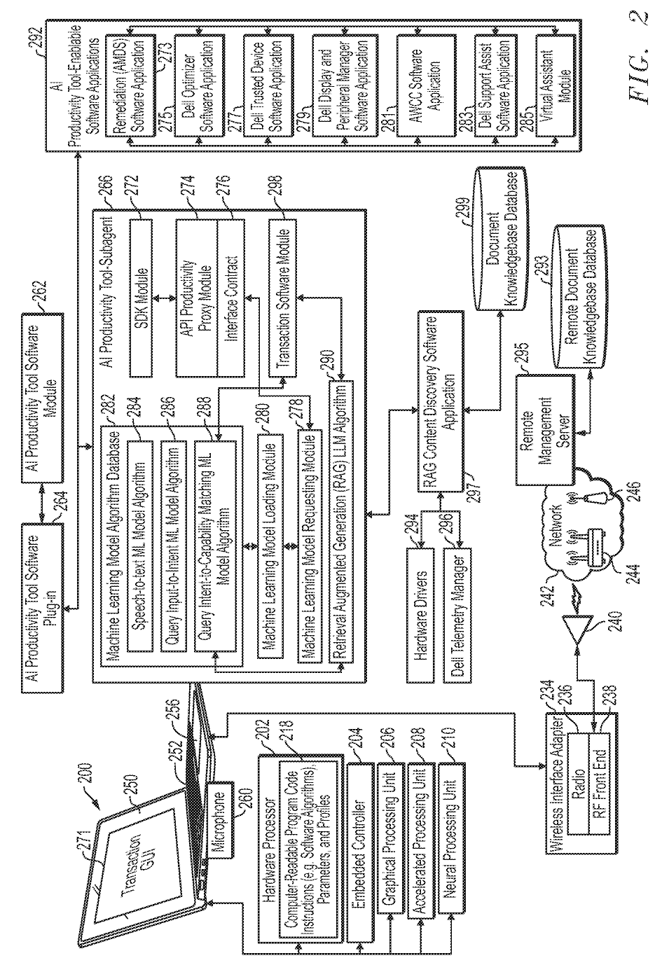

FIG. 2 is a graphic and block diagram illustrating an information handling system an information handling system executing computer readable code instructions of an AI productivity tool software module to select among a plurality responsive capabilities of AI productivity tool-enablable software applications to a user query input and provide a generated capability intent action feedback summary and an executed capabilities log according to an embodiment of the present disclosure. As described herein, the information handling system 200 in FIG. 2 is shown as a laptop-type information handling system 200. The information handling system 200 may include a video display device 250 to provide output to the user, such as via a transaction GUI 271, as well as a keyboard 252, a touchpad 256, and microphone 260 for the user to provide input to the information handling system 200. It is appreciated that other types of information handling systems may be used and the information handling system 200 presented in FIG. 2 is presented as an example of an information handling system 200 that can be used with the systems and methods described herein.

As described in embodiments herein, the information handling system 200 includes an AI productivity tool software modules 262 and an AI productivity tool software plug-in 266 to receive user query input and provide that user query input to the AI productivity tool subagent 266. In an embodiment, this user query input may include the user, via the AI productivity tool software module 262, “make my system run faster.” In this example embodiment, the user may have detected that input at the information handling system 200 is being processed slowly. The user may be seeking to fix this issue and allow the AI productivity tools of the information handling system 200 to provide a remedy.

In an embodiment, the AI productivity tool software module 262 may include an original equipment manufacturer (OEM) AI productivity tool with a set of capabilities that are executable on the information handling system 200 in embodiments of the present disclosure. In the embodiments herein, the user query input may include audio input received from, for example, the microphone 260. In another embodiment, the user query input may include text input by the user by the keyboard 252. In an embodiment, the execution of the computer-readable program code instructions 218 of the AI productivity tool subagent 266 by the hardware processor 202 or any other hardware processing device selects among a plurality of available ML module algorithms 284, 286, 288 maintained within a ML model algorithm database 282 for use with execution of the plurality of AI productivity tool software module 262.

The AI productivity tool software module 262 may invoke one or more sets of capabilities of AI productivity tool-enablable software applications executable on the information handling system 200 according to embodiments of the present disclosure. As described herein, the computer-readable program code instructions 218 of the AI productivity tool software module 262 with an AI productivity tool subagent 266 as well as available ML module algorithms 284, 286, 288 may be executed by a hardware processor 202 or other ML model algorithm execution provider hardware processing resource on the information handling system 200. The execution of code instructions of the AI productivity tool subagent 266 as well as available ML module algorithms 284, 286, 288 thereby allow the processes of the AI productivity tool software module 262 to identify responsive capabilities from among their respective sets of capabilities and respond to received user query inputs according to methods described herein. Again, the identification of these capabilities is responsive to the user query input of “make my system run faster.” The execution of the AI productivity tool subagent or subagent 266 as well as available ML module algorithms 284, 286, 288 for the AI productivity tool software module 262 may be carried out on-the-box such that a wired or wireless network connection to a network is not necessary for operation of the method. In another embodiment, some modules, databases, and/or processing resources such as ML module algorithms 284, 286, 288 may be maintained on a remote server (e.g., remote management server 295) such that a wired or wireless network connection can be made with these remote servers and the method may be implemented as described herein.

As described, the AI productivity software tool module 262 may include any artificial intelligence-based productivity tool to assist in interfacing with and execution of the AI productivity tool-enablable software applications 292 and receive user query inputs from a user and generate responses as responsive capability intent actions at an information handling system 200. The AI productivity software tool module 262 may be loaded on-the-box by an OEM manufacturer or via uploads in software from one or more independent software vendor (ISVs), such as an operating system ISV. The AI productivity software tool module 262 may include chatbot features, virtual assistant features, and other artificial intelligence features that allow a user to provide input to the information handling system 200 and, with generative artificial intelligence processing of the user query input, execute one or more responsive capabilities from various sets of capabilities that include hardware operations, functions, software services such as by using one or more AI productivity tool-enablable software applications 292. Examples of some types of AI productivity software tool modules 262 may include Cortana ® by Microsoft ®, Copilot ® by Microsoft ®, Siri ® by Apple ® Inc., Gemini ® by Google AI®, ChatGPT ® by OpenAI ®, and Amazon Alexa ® by Amazon ®, among others. It is appreciated that the information handling system 200 may include any proprietary AI productivity tool software module 262 that is an OEM AI productivity tool installed by an information handling system 200 manufacturer and used to interface with the information handling system 200 and the operations thereon. In various embodiments, the hardware processor 202 or other alternative hardware processing resources of the information handling system 200 may execute computer-readable program code instructions of the AI productivity software tool module 262 and the AI productivity tool plug-in 264 to monitor for user input for a user query at a microphone 260, keyboard 252, or other input device for the AI productivity tool subagent 266 to engage in determining capability intent actions responsive to the user query input.

The AI productivity software tool module 262, executing on the hardware processor 202, such as a CPU, or other hardware processing resource (e.g., EC 204, GPU 206, APU 208, or NPU 210), may interface with other hardware components and with the AI productivity tool-enablable software application 292 as well as the one or more ML module algorithms 284, 286, 288 via an AI productivity tool plug-in 266. The AI productivity tool subagent 266 may be any software and/or firmware executable by the hardware processor 202 or other hardware processing resources 202, 204, 206, 208, 210 of the information handling system 200 to interface with one or more of the plurality of the AI productivity tool-enablable software applications 292 to provide AI enabled capabilities within those AI productivity tool-enablable software applications 292 for responsive hardware, firmware, or software operations, functions, software services, or responses to user input queries. In an embodiment, the computer-readable program code instructions of the AI productivity tool-enablable software applications 292 may operate wholly “on-box” within the information handling system 200 or be sub-agents on-box for interfacing with remote software systems executing at remote server locations.

In an embodiment, during operation, the hardware processor 202 or other hardware processing resource (e.g., EC 204, GPU 206, CPU, APU 208, or NPU 210) executes computer-readable program code instructions of the AI productivity tool subagent 266. The AI productivity tool subagent or subagents 266 may engage with a machine learning model requesting module 278 to have one or more ML module algorithms 284, 286, 288 loaded and executed on the hardware processor in order to, initially, determine the query intent value of a user query input and to correlate it with a capability intent action to be conducted responsive to the received user query inputs.

In an embodiment, the execution of the computer-readable program code instructions of the AI productivity tool subagent 266 may call a software development kit (SDK) module 272. The SDK module 272 may include any computer-readable program code instructions that is executed by the hardware processor 202 or other hardware processing resource to request that a ML module algorithms 284, 286, 288 that may be invoked to support the identification of, in an embodiment, one or more capability intent action based on received user query inputs from a user at the AI productivity software tool module 262.

In example embodiments herein, the ML module algorithms 284, 286, 288 may include a query input-to-intent ML model algorithm 286 that receives the user query input, and with an embedding algorithm generates a vectorized query intent value for the user query input for later correlation with a capability intent value. In embodiments where the user query input is in audio form such as when the user uses the microphone 260 to state “make my system run faster,” the AI productivity tool subagent 266, via the SDK module 272, may invoke the execution of a speech-to-text ML model algorithm 284 to initially convert this audio into text for use with the query input-to-intent ML model algorithm 286 to generate the vectorized query intent value for the user query input for later correlation with a capability intent value as described herein. In an example embodiment, the ML module algorithms 284, 286, 288 may also include a query intent-to-capability matching ML model algorithm 288. The query intent-to-capability matching ML model algorithm 288 receives the vectorized query intent value from the execution of the query input-to-intent ML model algorithm 286 as input and then matches the vectorized query intent value to a vectorized capability intent value associated with the AI productivity tool-enablable software application 292 or a response via a similarity correlation algorithm for lexical or semantic matching to identify a responsive capability or response that can serve as the capability intent action responsive to a user query input.

Similarly, additional user chat inputs for a multi-turn user chat exchange may be processed by the AI productivity tool software module 262 to identify a supplemental input from the user, such as an approval or customizing data input (e.g., for levels or other features of a capability). Further, the AI productivity tool software module 262 process additional user chat inputs to identify text or audio responses for the user using the ML model algorithms 284, 286, and 288 similar to the above. The additional user chat inputs may be embedded as query intent values and then lexically or semantically matched, via ML model algorithms 284, 286, and 288, with determination of the supplemental input from the user, for approvals, customizing inputs, or modifications requested to the responsive user query input. Further, additional user chat inputs may be embedded as query intent values and then lexically or semantically matched, via ML model algorithms 284, 286, and 288, with text responses from a large language model (LLM) system for the multi-turn chat exchange in example embodiments. This supplemental input, for approvals or customizing input data, or generated responses from the multi-turn user chat exchange may be recorded with the user query input by the AI productivity tool software module 262 in embodiments herein, for presentation along with human-readable generated capability intent feedback summary descriptions of responsive capabilities to a user query input and any executed capabilities transaction log.

In embodiments of the present disclosure, the capabilities may include capabilities associated with the AI productivity tool-enablable software applications 292 as accessible through the AI productivity software tool module 262. Example AI productivity tool-enablable software applications 292 may include Dell ® Optimizer® software application 275, Dell® SupportAssist® software application 283, as well as any other AI productivity tool-enablable software applications 292 described herein (e.g., Remediation (AMDS) software application 273, Dell® Trusted Device software application, Dell® display and peripheral device manager software application 279, Alienware ® Command Center (AWCC) software application, and a virtual assistant module 285) that can change features, settings, or other actions on the information handling system associated with, for example, information handling system 200 adjustments or adjustments to built-in peripheral devices (e.g., video/graphics display device 250, trackpad 256, keyboard 252). It is appreciated that capabilities associated with the AI productivity tool-enablable software applications 292 may include adjustments to a brightness of the video/graphics display device 250, power adjustments at the PMU 228, adjustment to thermal tables (fan/acoustic/hardware processor throttling), system firmware indicator of attacks (IoAs), firmware vulnerability exposure and recommended migrations via Dell® Trusted Device® software application 277, among other changes to features, settings, or other characteristics on the information handling system 200. In the context of the user query input including the statement of “make my system run faster,” other capabilities may include increasing the clock frequency of a hardware processor, switch or elicit another hardware processor to compensate for a lack of hardware processing resources, change thermal table settings, stop execution of background applications, and the like that may, for example, be associated with Dell® Optimizer software application 275 or Dell® SupportAssist software application, for example.

It is appreciated that the selected ML module algorithms 284, 286, 288 for a similar or common identified AI productivity-tool operation type may satisfy an interface contract 276 requested by the AI productivity tool subagent 266 such that the query intent value from the user query inputs or additional user chat inputs may be interpreted and an available capability associated with one of the plurality of AI productivity tool-enablable software applications 292 as the capability intent action can be matched to the user’s query input or capabilities, supplemental inputs to capabilities, or responses may be matched to additional user chat inputs. The interface contract 276 described herein defines the requirements that selected ML module algorithms 284, 286, 288 are to have in order to be able receive a specific type of input from the AI productivity tool software module 262, the AI productivity tool subagent 266, or any AI productivity tool-enablable software application 292 and to provide a specific type of output to the AI productivity tool subagent 266, the AI productivity tool software module 262, and/or AI productivity tool-enablable software applications 292. In an embodiment, the interface contract 276 is generated by an AI productivity proxy API 274 invoked by the SDK module 272 in order to identify the similar or common productivity-tool operation type ML module algorithms 284, 286, 288 that provides the appropriate output to the AI productivity tool subagent 266.

As described herein, the plurality of identified responsive capabilities associated with any of the AI productivity tool-enablable software applications 292 may be received by a transaction software module 298. In an embodiment, the receipt of these identified responsive capabilities by the transaction software module 298 occurs prior to the capability intent actions associated with each of the identified capabilities being carried out by their respective AI productivity tool-enablable software applications 292 responsive to a user query input. Execution of the computer-readable program code instructions, parameters, and profiles 218 of the transaction software module 298 causes a determination to be made as to whether additional user chat inputs will occur in an embodiment. For example, the transaction software module 298 may determine that the user needs to consent to the execution of those identified capabilities in an embodiment. In another embodiment, the transaction software module 298 may determine that additional customizing input may be required such as an indication of a level in various embodiments (e.g., a volume level, brightness level, or others for a capability intent action to adjust volume or brightness) for execution of one or more responsive capabilities. In some example embodiments, some of the capabilities may not need authorization from the user in order to be executed when, for example, the capability is associated with an AI productivity tool-enablable software applications 292 that periodically executes their capabilities such as an antivirus or antimalware AI productivity tool-enablable software application 292. However, the AI productivity tool software module 162 may execute a user conversational interface that indicates that a multi-turn additional chat exchange is occurring with the user indicating to the transaction software module 298 that additional user chat inputs are or will be received which may modify responsive capability selection or responses to the user in other embodiments. In another example, certain policies may indicate that, regardless of the user’s input, certain capabilities must be allowed to be executed and, therefore, in some embodiments the user is never made aware of such an identified capability or, at least, not allowed to choose whether the capability is executed or not.

In some example embodiments, the execution of the computer-readable program code instructions, parameters, and profiles 218 of the transaction software module 298 may determine that some or all identified capabilities require approval from the user prior to execution of the capabilities by one or more of the AI productivity tool-enablable software applications 292. In some example embodiments, the execution of the computer-readable program code instructions, parameters, and profiles 218 of the transaction software module 298 may determine that some or all identified capabilities require additional user chat inputs to provide customizing input data, such as for levels or selection of other feature options of one or more responsive capabilities. In order to solicit this approval to execute the identified capabilities or the customizing input data (e.g., for levels, etc.), the transaction software module 298 may invoke a retrieval augment generation (RAG) LLM algorithm 290. The RAG LLM algorithm 290 may include any computer-readable program code instructions that receives input from one or more sources and provides as output human-readable text that is then presented to a user to read and act on accepting or not accepting the implementation of or provide customizing data inputs for the identified responsive capabilities.

In an embodiment, a number of sources of document knowledgebase databases for document knowledgebase text data that may be drawn from user guides (associated with the information handling system or AI productivity tools), integration guides, frequently asked questions (FAQs) sources, hardware specifications, and the like. This document knowledgebase text data can be used as input at the RAG LLM algorithm 290 along with descriptive API calls or natural language descriptions of responsive capabilities to determine context embeddings and capability labels in text format for generating a human-readable summary of identified responsive capabilities that can be presented to a user. In an embodiment, execution of computer-readable program code instructions, parameters, and profiles 218 of a RAG content discovery software application 297 may be initiated by the transaction software module 298 to discover any pertinent information related to the API or natural language description of a responsive capability from a document knowledgebase database that match document knowledgebase text data from user guides associated with the information handling system or AI productivity tools, integration guides, frequently asked questions (FAQs) sources, hardware specifications, and the like. This may be used by the RAG LLM algorithm 290 along with the user query input, any natural language description of the capability, and the capability intent action API to generate the human readable summary of the identified responsive capability.

In an example embodiment, the information handling system 200 may include a document knowledgebase database 299 that stores, for example, any user guides (associated with the information handling system or AI productivity tools), integration guides, FAQs sources, and hardware specifications associated with the hardware and software (e.g., AI productivity tool-enablable software applications 292) that may be associated with any of the identified responsive capabilities or execution via APIs of those identified responsive capabilities. The document knowledgebase database 299 may be propagated with this information by the OEM or ISV during manufacture of the information handling system 200 and/or uploading of the software from the ISV. Additionally, the information handling system 200 may gain access to a remote document knowledgebase database 293 on a remote management server 295 that may include the same or additional user guides (associated with the information handling system or AI productivity tools), integration guides, FAQs sources, and hardware specifications. This remote management server 295 and remote document knowledgebase database 293 may be accessed through the use of the wireless interface adapter 234 or a wired network interface accessing a network 242 where the remote management server 295 is located as described herein in.

In an embodiment, any number of hardware drivers 294 may be accessed to also gain additional specifications related to each hardware device within the information handling system 200 as document knowledgebase text data. In an embodiment, details regarding the make and model of the hardware devices, associated processing or storage resources, current drier details, and the like may also be used as document knowledgebase text data input to the RAG LLM algorithm 290.

As described herein, as this input is provided to the RAG LLM algorithm 290 by the RAG content discovery software application 297, output may be received at the transaction software module 298 describing, in human-readable form, a generated capability intent feedback summary of those identified responsive capabilities and the hardware, firmware, and/or software that will be affected by the execution of these capabilities. Continuing with the example presented in FIG. 2, the user may be presented with a description of the responsive capability that the current hardware processor may be overclocked in order to increase processing resources in the information handling system. This description may also include human-readable summary in text of a responsive capability that indicates (per description assisted with access to input document knowledgebase text data for user guides, integration guides, FAQs sources, and hardware specifications) consequences of executing this responsive capability. For example, generated human-readable capability intent feedback summary may describe the responsive capability and consequences such as the possibility of the fan speed and noise increasing due to the additional heating of the hardware processor and increased heat detectable by the user at certain physical locations along the housing of the information handling system if overclocking is initiated. Another example generated human-readable capability intent feedback summary may include the user being presented with the responsive capability of the information handling system to sequester or otherwise use the processing resources of another hardware processor available at the information handling system 200. This may be presented alongside the optional responsive capability of overclocking a first hardware processor so that the user can determine whether to select one or both of the responsive capabilities to remedy the perceived issue of a slow processor as detected by the user and presented in the user query input. In yet another example, the identified responsive capability may include closing background applications, and generated human-readable capability intent feedback summary may describe the responsive capability and consequences from stopping these background applications that may include lost work or reduced functionalities or security protections at the information handling system 200.

In an embodiment, the generated human-readable capability intent feedback summary output may also include a description of which AI productivity tool-enablable software application 292 will execute their respective responsive capability in order to invoke changes to features, settings, or other actions on the information handling system as described herein. This may be beneficial if the user is concerned that certain hardware changes made by a non-OEM AI productivity tool-enablable software application 292, for example, may not appropriately address the user’s issue of detecting slow processing power. As described, this generated human-readable capability intent feedback summary output from the transaction software module 298 may be presented to the user as a transaction GUI 271 presented on, for example, the video/graphics display device 250. In an embodiment, the user may read the presented information of the generated human-readable capability intent feedback summary output the transaction GUI 271 related to description of each identified responsive capability, consequences of executing these responsive capabilities on hardware, firmware or software, and their respective AI productivity tool-enablable software application 292. The user may then confirm or deny, via actuation of any button presented on the GUI or via additional user chat inputs for example, that the responsive capability and its associated capability intent action is to be executed by the identified AI productivity tool-enablable software applications 292 or not executed at all. Further, the user may read the presented information of the generated human-readable capability intent feedback summary output the transaction GUI 271 related to required additional customizing data inputs, for levels or feature settings, for the responsive capabilities. The user may then input selection of level values or feature setting selections, via actuation of any button presented on the GUI or via additional user chat inputs for example, for customizing the responsive capability and its associated capability intent action.

The systems and methods described herein, therefore, allows for a user to be notified of change to features, settings, or other actions on the information handling system through execution of the computer-readable program code instructions, parameters, and profiles 218 of the transaction software module 298 described herein. In the embodiments herein, the user is made aware of detected capabilities responsive to the user query input via generated human-readable capability intent feedback summary output presented on a transaction GUI 271 prior to the execution of those responsive capabilities. This allows the user to know exactly which responsive capabilities are available or are being executed, how they will affect the operation of the information handling system 200, and which AI productivity tool-enablable software application 292 will be executing those capabilities. Further, the user may follow a series of the user query input, additional user chat inputs, responses from the AI productivity tool software module 262, or descriptions of the responsive capabilities and approvals in the generated human-readable capability intent feedback summary output presented on a transaction GUI 271 in embodiments herein. Further, the user may continue with a multi-turn user chat exchange with the AI productivity tool software module 262 to independently add, modify, or adjust execution of responsive capability intent actions while monitoring the generated human-readable capability intent feedback summary output presented on a transaction GUI 271. This provides additional opportunities for customization by the user when providing user query input to the AI productivity tool software module 262.

In an embodiment, the transaction software module 298 may further generate a generate an executed capabilities log describing user-approved responsive capabilities executed at the information handling system 200 and transmit that executed capabilities log to the remote management server 295 accessible to an intent technology decision maker (ITDM) for analysis by the ITDM. This data may provide the ITDM with additional information related to how the user customizes the execution of various capabilities identified after the user has provided user query input to the AI productivity tool software module 262. The ITDM may use this information to, for example, propagate similar customizations to other information handling systems within an enterprise thereby leveraging this customization for other users of other information handling systems.

Additionally, the human-readable generated capability intent feedback summary output of the identified responsive capabilities as well as the user query input, additional user chat inputs, and AI productivity tool software module 262 responses may be sent to the remote management server 295. This data may provide the ITDM with additional information related to how the user customizes the execution of various capabilities identified after the user has provided user query input to the AI productivity tool software module 262 or provide insight into flaws or faults with the AI productivity tool software module 262 or its available capabilities. The ITDM may use this information to, for example, make modifications or improvements to the AI productivity tool software modules 262 deployed or to available capabilities provided.

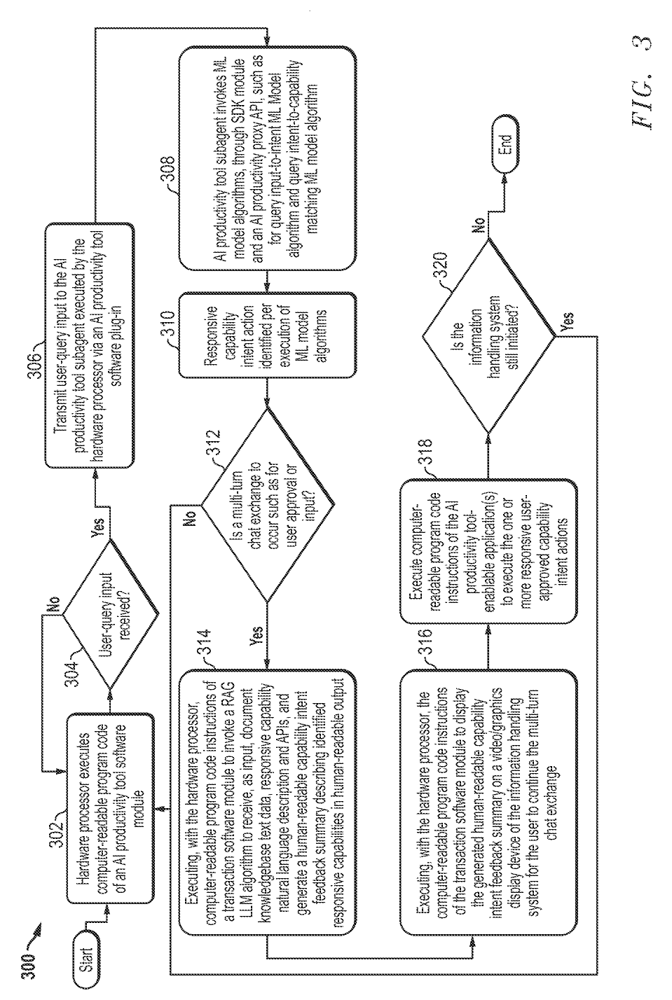

FIG. 3 is a flow diagram showing a method of executing computer readable code instructions for providing a generated capability intent action feedback summary to a user operating an AI productivity tool software module at an information handling system according to an embodiment of the present disclosure. The method 300 described in connection with FIG. 3 may be operated on an information handling system such as an information handling system (e.g., 100, 200) described in connection with FIGS. 1 or 2. In an embodiment, the systems and methods described herein may operate on the information handling system such that the method is executed “on-the-box” such that a wired or wireless network connection to a network is not necessary for operation of the method. In another embodiment, some modules, databases, and/or processing resources may be maintained on a remote server and a wired or wireless network connection can be made with these remote servers and the method may be implemented as described herein.

The method 300 may include, at block 302, the hardware processor or other hardware processing device of the information handling system executing computer-readable program code instructions of the AI productivity tool software module including access to the AI productivity tool software application executing on the information handling system. In an embodiment, the AI productivity tool software module may be any application that can receive input from a user such as text input via the keyboard or speech input via the microphone. In some embodiments, text or audio may be received by an interface of the one or more AI productivity tool software applications and the interface managed by the AI productivity tool software module at block 302. In an embodiment, the AI productivity tool software module may include a virtual assistant-type AI software agent. In various embodiments, the hardware processor or other alternative hardware processing resources of the information handling system may execute computer-readable program code instructions of the AI productivity tool software application or AI productivity tool software module with its AI productivity tool software plug-in and monitor for user query inputs at a microphone, keyboard, or other input device for the AI productivity tool subagent to engage in capability intent actions pursuant to the user query inputs.

At block 304, the method 300 also includes determining whether any user query input has been received at the AI productivity tool software module of each of the node information handling systems. The AI productivity tool plug-in may monitor for input from an input/output device such as a trigger word or trigger keystroke for audio user query inputs or activation of a graphical user interface to receive text user query inputs. Where, at block 304, no user query input is received, the method 300 returns to block 302 with the AI productivity tool software module continuing to monitor for this input. Where, at block 304, the AI productivity tool software module does detect and receive user query input, the method 300 continues to block 306.

At block 306, the user query input is transmitted to a capability intent identification system such as the AI productivity tool subagent and its modules, algorithms, and software applications being executed by the hardware processor of the information handling system. In an embodiment, the AI productivity tool subagent may provide some or all of the AI productivity services as described herein.

At block 308, the method 300 continues with the AI productivity tool subagent requesting one or more ML model algorithms through an SDK module and an AI productivity proxy API to process a user query input and identify one or more responsive capabilities at the information handling system. For example, the machine learning model loading module, pursuant to the interface contract generated by the AI productivity proxy API, may load a speech-to-text ML model algorithm in order to, where necessary, convert any audio user query input into text or other machine-readable program code instructions for further processing by the AI productivity tool subagent. Additional ML model algorithms may be requested as well to generate query intent value for semantic meaning values assigned to the user query input as well as for conducting any semantic or lexical similarity matching with capability intent values to determine responsive capability intent value actions to the user query input in various embodiments herein. The AI productivity proxy API transmits this request for the ML model algorithms to the ML model requesting module. The ML model loading module loads the appropriate ML model algorithms pursuant to the request from the ML model requesting module.

In an embodiment, a speech-to-text ML model algorithm may be included among the plurality of available ML model algorithms. The speech-to-text ML model algorithm may, where necessary, convert any audio user query input into text or other machine-readable program code instructions for further processing by the AI productivity tool subagent. The ML model algorithms may also include a query input-to-intent ML model algorithm that receives the user query input, or any additional user chat input, from the speech-to-text model algorithm or directly from the AI productivity tool subagent, and, with an embedding algorithm, generates a vectorized query intent value for the user query input or additional user chat inputs for later correlation with one or more capability intent values or with LLM responses. Additionally, a query intent-to-capability matching ML model algorithm may receive that vectorized query intent value as input and match the vectorized query intent value to one or more vectorized capability intent values associated with the AI productivity tool-enablable software application or with LLM generated responses via a similarity correlation algorithm to identify one or more responsive capabilities that can serve as one or more capability intent actions responsive to a user query input or to identify a text or audio response during a multi-turn user chat exchange in response to additional user chat inputs.

At block 310, the method 300 includes one or more capability intent actions being identified via the execution of the ML model algorithms identifying one or more responsive capabilities associated with one or more of the AI productivity tool-enablable software applications. In the context of the user query input received from the user (e.g., “make my system run faster”) one or more of the AI productivity tool-enablable software applications may be used to execute responsive capability intent actions to adjust the clock frequency of a hardware processor, change from one hardware processor to another, engage a second hardware processor to share processing resources, stop background applications from running, cause the information handling systems to enter a “performance mode,” free up RAM space, or other responsive capability intent actions. For example, the Dell ® Optimizer ® software application, or any other AI productivity tool-enablable software application may have a matching responsive capability that can fix the issues the user is having with slow processing that is responsive to a user query input or additional user chat inputs from the user at the information handling system.

At block 312, the method 300 further includes the hardware processor executing computer readable code instructions of the AI productivity tool software module and a transaction software module for determining that a multi-turn additional user chat exchange will occur with the AI productivity tool software module. This may occur when a capability intent action responsive to one of the identified plurality of responsive capabilities requires user approval. This may occur when a capability intent action responsive to one of the identified plurality of responsive capabilities requires additional user inputs for customization data, such as related to specifying levels or feature settings of a responsive capability. Execution of the computer-readable program code instructions, parameters, and profiles of the transaction software module causes a determination to be made as to whether the user needs to consent to the execution of some portion of identified responsive capabilities, or one or more responsive capabilities require additional user chat inputs for level settings or feature selection. Also, determining that a multi-turn additional user chat exchange will occur may be prompted by the AI productivity tool software module when a user query interface detects additional user chat inputs indicating the user desires an ongoing multi-turn user chat exchange in which a user may initiate changes, modifications, selection, approval, or other additional user chat inputs relative to the identified responsive capabilities in some embodiments.

As described herein, the receipt of these identified capabilities by the transaction software module occurs prior to the capability intent actions associated with each of the identified capabilities being carried out by their respective AI productivity tool-enablable software applications. In some embodiments, the identified responsive capabilities may not need authorization or additional user chat inputs from the user in order to be executed when, for example, the capability is associated with an AI productivity tool-enablable software applications that periodically executes their capabilities such as an antivirus or antimalware AI productivity tool-enablable software application. In another example, certain policies may indicate that, regardless of the user’s input, certain capabilities must be allowed to be executed and, therefore, in some embodiments the user is never made aware of such an identified capability or, at least, not allowed to choose whether the capability is executed or not. In other embodiments, no additional user chat inputs are needed or desired by the user. Where it is determined that a multi-turn additional user chat exchange will occur with the AI productivity tool software module, the method 300 continues to block 314. However, where no further multi-turn additional user chat exchange will occur with the AI productivity tool software module, the method 300 returns to block 302 to monitor for additional user query inputs as described herein.

At block 314, the method 300 also includes executing, with the hardware processor, computer-readable program code instructions of the transaction software module to invoke a RAG LLM algorithm to receive, as input, document knowledgebase text data via access to a document knowledgebase database and generate a generated human-readable capability intent feedback summary including the identified plurality of responsive capabilities in human-readable output. The RAG LLM algorithm may include any computer-readable program code instructions that receives input from one or more sources and provides as output human-readable text for a generated human-readable capability intent feedback summary that is then presented to a user to read and act on for accepting or not accepting the implementation of the identified responsive capabilities, provide required customizing inputs, or to initiate modifications or changes via an ongoing multi-turn user chat exchange.

In an embodiment, document knowledgebase databases contain a number of sources of document knowledgebase text data including user guides (associated with the information handling system or AI productivity tools), integration guides, FAQs sources, hardware specifications, and the like that can be used as input at the RAG LLM algorithm. The hardware processor executing computer readable code instructions of the RAG LLM algorithm may determine context embeddings and capability labels related to a natural language description of responsive capabilities or APIs to be executed by responsive capabilities to generate a human-readable description in text format of the responsive capability or capabilities that can be presented to a user in the human-readable capability intent feedback summary. In an embodiment, execution of computer-readable program code instructions, parameters, and profiles of a RAG content discovery software application may be initiated by the transaction software module to discover any pertinent information related to responsive capability and draw from document knowledgebase text data such as the user guides associated with the information handling system or AI productivity tools, integration guides, FAQs sources, hardware specifications, and the like to generate the human-readable capability intent feedback summary description of the responsive capability and hardware, software, or firmware consequences from executing the responsive capability in embodiments herein.

In an example embodiment, the information handling system may include a document knowledgebase database that stores, for example, any user guides (associated with the information handling system or AI productivity tools), integration guides, FAQs sources, and hardware specifications associated with the hardware and software (e.g., AI productivity tool-enablable software applications) that are associated with any of the identified capabilities. The document knowledgebase database may be propagated with this information by the OEM or ISV during manufacture of the information handling system and/or uploading of the software from the ISV. Additionally, the information handling system may gain access to a remote document knowledgebase database on a remote management server that may include the same or additional user guides (associated with the information handling system or AI productivity tools), integration guides, FAQs sources, and hardware specifications. This remote management server and remote document knowledgebase database may be accessed through the use of the wireless interface adapter accessing a network where the remote management server is located as described herein in.

In an embodiment, any number of hardware drivers may be accessed to also gain additional specifications related to each hardware device within the information handling system as additional document knowledgebase text data. In an embodiment, details regarding the make and model of the hardware devices, associated processing or storage resources, current driver details, and the like may also be used as document knowledgebase text data input to the RAG LLM algorithm.

As described herein, as this document knowledgebase text data input is provided to the RAG LLM algorithm by the RAG content discovery software application, output may be received at the transaction software module describing, in human-readable form, those identified responsive capabilities and the hardware, firmware, and/or software that will be affected by the execution of these capabilities in the generated human-readable capability intent feedback summary. Further, the generated human-readable capability intent feedback summary may include the user query input, additional user chat inputs, generated responses from the AI productivity tool software module in an ongoing use chat exchange, as well as execution status of responsive capabilities among other data so a user may view this information to assist in responding to the AI productivity tool software module if necessary.

In an example embodiment, the user may be presented with a responsive capability description that the current hardware processor may be overclocked in order to increase processing resources at the information handling system after the user has provided user query input of “make my system run faster.” This description in the generated human-readable capability intent feedback summary may include human-readable text that describes the responsive capability as well as indicates (per the document knowledgebase text data from user guides, integration guides, FAQs sources, and hardware specifications) consequences of executing this capability such as the possibility of the fan speed and noise increasing due to the additional heating of the hardware processor and increased heat detectable by the user at certain physical locations along the housing of the information handling system.

Another example may include the user being presented with a generated human-readable capability intent feedback summary describing the responsive capability of the information handling system to sequester or otherwise use the processing resources of another hardware processor available at the information handling system as an alternative in an embodiment. In an embodiment, this second responsive capability may be provided alongside the optional capability of overclocking a first hardware processor so that the user can determine whether to select one or both of the responsive capabilities to remedy the perceived issue of a slow processor as detected by the user and presented in the user query input. In yet another example, the generated human-readable capability intent feedback summary may describe an identified responsive capability may include closing background applications, and the user may also be presented with consequences of stopping these background applications that may include lost work or reduced functionalities at the information handling system.

In an embodiment, the human-readable capability intent feedback summary output may also include a description of which AI productivity tool-enablable software application will execute their respective responsive capability in order to invoke changes to features, settings, or other actions on the information handling system as described herein. This may be beneficial if the user is concerned that certain hardware changes made by a non-OEM AI productivity tool-enablable software application may not appropriately address the user’s issue of detecting slow processing power for example.

The method further includes, at block 316, executing, with the hardware processor, the computer-readable program code instructions of the transaction software module to display the generated capability intent action feedback summary of the identified plurality of responsive capabilities in human-readable output on a video/graphics display device of the information handling system for the user to approve the execution of the identified plurality of responsive capabilities. As described, this generated capability intent action feedback summary output from the transaction software module may be presented to the user as a transaction GUI presented on, for example, the video/graphics display device. In an embodiment, the user may read the presented information on the transaction GUI related to each discovered responsive capability, consequences of executing these responsive capabilities, their respective AI productivity tool-enablable software application, and an ongoing record of the user query input and user chat exchange with the AI productivity tool software module.

At block 318, the user may then confirm or deny, via actuation of any button presented on the GUI or via additional user chat inputs for example, that the responsive capability and its associated capability intent action is to be executed by the identified AI productivity tool-enablable software applications or not executed at all. Further, in other embodiments, the user may input customizing data inputs for levels or feature settings, via actuation of any button presented on the GUI or via additional user chat inputs for example, for the responsive capability and its associated capability intent action. In yet other embodiments, the user may continue a multi-turn user chat exchange with additional user chat inputs to initiate a change, modification, or customization, via additional user chat inputs for example, to the responsive capability and its associated capability intent action. Therefore, computer-readable program code instructions of one or more AI productivity tool-enablable applications may be executed to invoke the one or more user-approved responsive capability intent actions identified at block 310 and approved or modified by the user at block 316. The hardware processor may execute computer readable code instructions of one or more AI productivity tool-enablable software applications to execute the user approved or modified responsive capability intent actions in embodiments herein.

In a further embodiment at block 318, the hardware processor may execute computer-readable program code instructions of the transaction software module to generate an executed capabilities log describing user-approved responsive capabilities executed at the information handling system and transmit that executed capabilities log and any a generated capability intent action feedback summary, user query input, as well as additional user chat inputs and AI productivity tool software module responses, to a remote management server accessible to an ITDM for analysis by the ITDM. This further allows the ITDM to discern which capabilities were accepted by the user and how those capabilities were described to the user via execution of the transaction software module and the RAG LLM algorithm.

At block 320, the method 300 includes determining if the information handling system is still initiated. Where the information handling system is still initiated, the method 300 proceeds to block 302 as described herein. Where the information handling system is no longer initiated, the method 300 may end here.

The blocks of the flow diagrams of FIG. 3 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system to provide an intent action feedback summary to a user of an artificial intelligence (AI) productivity tool software module at the information handling system comprising:
a hardware processor, a data storage device, and a power management unit (PMU) to provide power to the hardware processor and data storage device;
the hardware processor to execute computer-readable program code instructions of an AI productivity tool software module to receive a user query input and direct an AI productivity tool plugin to invoke a plurality of machine learning (ML) model algorithms to identify a plurality of responsive capabilities associated with AI productivity tool-enablable software applications that semantically or lexically match as responsive to the user query input;
the hardware processor to execute computer-readable program code instructions of a transaction software module to determine that a capability intent action responsive to one of the identified plurality of responsive capabilities requires additional user chat input;
the hardware processor to execute computer-readable program code instructions of the transaction software module to invoke a retrieval augmented generation (RAG) LLM algorithm to receive, as input, document knowledgebase text data via access to a document knowledgebase database and generate a summary of the identified plurality of responsive capabilities in human-readable output and the user query input; and
the hardware processor to execute the computer-readable program code instructions of the transaction software module to display the generated capability intent feedback summary of the identified plurality of responsive capabilities in human-readable output on a video/graphics display device of the information handling system for the user to continue additional user chat input via the AI productivity tool software module to execute the identified plurality of responsive capabilities.

2. The information handling system of claim 1 further comprising:
the hardware processor executing computer-readable code instructions of a RAG content discovery software application to access the document knowledgebase database including the document knowledgebase text data from manufacturer user guides associated with the information handling system or AI productivity tools, integration guides, frequently asked questions (FAQs) sources, and hardware specifications and provide the document knowledgebase text data to the RAG LLM algorithm as input at the RAG LLM algorithm.

3. The information handling system of claim 1 further comprising:
the hardware processor executing computer readable code instructions of the RAG LLM algorithm identifies context embeddings and capability labels in text format within the document knowledgebase text data matching the identified plurality of responsive capabilities to generate the generated capability intent feedback summary of the identified plurality of responsive capabilities in human-readable output.

4. The information handling system of claim 3 further comprising:
the hardware processor executing computer readable code instructions of the transaction software module to receive customizing data inputs from the user in the additional user chat input for settings of at least one responsive capability and signal to the AI productivity tool plugin to execute the capability intent actions associated with the identified plurality of responsive capabilities.

5. The information handling system of claim 1 further comprising:
the hardware processor to execute computer-readable program code instructions of the transaction software module to generate a executed capabilities log describing user-approved capabilities executed at the information handling system, where the additional user chat input includes user approval, and transmit the executed capabilities log and the additional user chat input to a remote management server accessible to an intent technology decision maker (ITDM) for analysis by the ITDM.

6. The information handling system of claim 1 further comprising:
the hardware processor to execute the computer-readable program code instructions of the transaction software module to display, on the video/display device, the generated capability intent feedback summary of the identified plurality of responsive capabilities, user query inputs in the additional user chat input, identification of responsive capabilities accepted by the user for execution at the information handling system in the additional user chat input, and outcomes of the execution of the identified plurality of responsive capabilities that resulted in changes to the operation of the information handling system.

7. The information handling system of claim 1 further comprising:
the hardware processor to execute computer-readable program code instructions of the transaction software module to receive approval for one or more responsive capabilities from the user in the additional user chat input and signal to the AI productivity tool plugin to execute the capability intent actions associated with the user-approved responsive capabilities.

8. The information handling system of claim 1 further comprising:
the hardware processor to execute computer-readable program code instructions of the transaction software module to, via a wireless interface adapter, access a remote document knowledgebase database containing document knowledgebase text data not present at the document knowledgebase database at the information handling system.

9. A method of providing an intent action feedback summary to a user of an artificial intelligence (AI) productivity tool software module at an information handling system comprising:
executing, with a hardware processor, computer-readable program code instructions of the AI productivity tool software module to receive a user query input and direct an AI productivity tool plugin to invoke a plurality of machine learning (ML) model algorithms to identify a plurality of responsive capabilities associated with AI productivity tool-enablable software applications that semantically or lexically match as responsive to the user query input;
executing, with the hardware processor, computer-readable program code instructions of a transaction software module to determine that a capability intent action responsive to one of the identified plurality of responsive capabilities requires user responses in additional user chat input, including a user approval;
executing, with the hardware processor, computer-readable program code instructions of the transaction software module to invoke a retrieval augmented generation (RAG) LLM algorithm to receive, as input, document knowledgebase text data via access to a document knowledgebase database and generate a generated capability intent feedback summary of the identified plurality of responsive capabilities in human-readable output; and
executing, with the hardware processor, the computer-readable program code instructions of the transaction software module to display the generated capability intent feedback summary of the identified plurality of responsive capabilities in human-readable output on a video/graphics display device of the information handling system for the user to approve the execution of the identified plurality of responsive capabilities via the additional user chat input.

10. The method of claim 9 further comprising:
executing, with the hardware processor, a RAG content discovery software application to access the document knowledgebase database with the document knowledgebase text data including user guides associated with the information handling system or AI productivity tools, integration guides, frequently asked questions (FAQs) sources, and hardware specifications and providing the document knowledgebase text data as input to the RAG LLM algorithm.

11. The method of claim 9, wherein the RAG LLM algorithm identifies context embeddings and capability labels in text format within the document knowledgebase text data matching the identified responsive capabilities to generate the summary of the identified plurality of responsive capabilities in human-readable output.

12. The method of claim 9 further comprising:
executing, with the hardware processor, computer-readable program code instructions of the transaction software module to generate an executed capabilities log describing user-approved responsive capabilities executed at the information handling system and transmit that executed capabilities log, the generated capability intent feedback summary of the identified plurality of responsive capabilities in human-readable output, the user query input, and the additional chat input to a remote management server accessible to an intent technology decision maker (ITDM) for analysis by the ITDM.

13. The method of claim 9 further comprising:
executing, with the hardware processor, computer-readable program code instructions of the transaction software module to receive customizing data inputs from the user in the additional chat input for settings of at least one responsive capability and signal to the AI productivity tool plugin to execute the capability intent actions associated with the user-approved responsive capabilities.

14. The method of claim 9 further comprising:
executing, with the hardware processor, computer-readable program code instructions of the transaction software module to receive approval from the user in the additional user chat input and signal to the AI productivity tool plugin to execute the capability intent actions associated with the user-approved responsive capabilities.

15. The method of claim 9 further comprising:
executing, with the hardware processor, computer-readable program code instructions of the transaction software module to, via a wireless interface adapter, access a remote document knowledgebase database containing document knowledgebase text data.

16. An information handling system to provide an intent action feedback summary to a user of an artificial intelligence (AI) productivity tool software module at the information handling system comprising:
a hardware processor, a data storage device, and a power management unit (PMU) to provide power to the hardware processor and data storage device;
the hardware processor to execute computer-readable program code instructions of the AI productivity tool software module to receive a user query input and direct an AI productivity tool plugin to invoke a plurality of machine learning (ML) model algorithms to identify a plurality of responsive capabilities associated with AI productivity tool-enablable software applications that semantically or lexically match as responsive to the user query input;
the hardware processor to execute computer-readable program code instructions of a transaction software module to determine that additional user chat input in an additional user chat exchange will occur;
the hardware processor to execute computer-readable program code instructions of the transaction software module to invoke a retrieval augmented generation (RAG) LLM algorithm to receive, as input, document knowledgebase text data from a knowledgebase database and generate a summary of the identified plurality of responsive capabilities in human-readable output;
the hardware processor to execute the computer-readable program code instructions of the transaction software module to display the generated capability intent feedback summary of the identified plurality of responsive capabilities, the user query input, and the additional chat input in human-readable output on a video/graphics display device of the information handling system for the user to conduct the additional user chat exchange with the AI productivity tool software module; and
the hardware processor to execute computer-readable program code instructions of the transaction software module to generate a capabilities execution log describing responsive capabilities executed at the information handling system and transmit that capabilities execution log and the generated capability intent feedback summary of the identified plurality of responsive capabilities and the user query inputs in human-readable output to a remote management server accessible to an intent technology decision maker (ITDM) for analysis by the ITDM.

17. The information handling system of claim 16 further comprising:
a RAG content discovery software application to, when executed by the hardware processor, access the document knowledgebase database, including document knowledgebase text data from user guides associated with the information handling system or AI productivity tools, integration guides, frequently asked questions (FAQs) sources, and hardware specifications and provide the document knowledgebase text data matching the responsive capabilities as input at the RAG LLM algorithm.

18. The information handling system of claim 16 further comprising:
the hardware processor executing computer readable code instructions of the RAG LLM algorithm to identify context embeddings and capability labels in text format within the accessed document knowledgebase text data to generate the generated capability intent feedback summary of the identified plurality of responsive capabilities in human-readable output.

19. The information handling system of claim 18, wherein the additional user chat exchange with the AI productivity tool software module requires additional user chat input to approve the execution of the identified plurality of responsive capabilities.

20. The information handling system of claim 16 further comprising:
the hardware processor to execute the computer-readable program code instructions of the transaction software module to display, on the video/display device, the generated capability intent feedback summary including the identified plurality of responsive capabilities, identification of those of the plurality of responsive capabilities accepted by the user for execution at the information handling system in the additional user chat input, and outcomes of the execution of the identified plurality of responsive capabilities that resulted in changes to the operation of the information handling system.
